(19) United States
(12) Patent Application Publication
(10) Pub. No.: US 2003/0086260 A1
(43) Pub. Date: May 8, 2003

(54) Illuminated halloween candy carrier

(76) Inventors: LeAnn Terrell, Lexington, KY (US); Teresa Kelly, Lexington, KY (US)

Correspondence Address: Law Offices of John D. Gugliotta, P.E., Esq., 202 Delaware Building, 137 South Main Street, Akron, OH, 44308, US

(21) Appl. No.: 10/010,550

(22) Filed: Nov. 8, 2001

(51) Int. Cl. F21L 4/00

(52) U.S. Cl. 362/154; 362/124; 362/808; 362/186

(57) ABSTRACT

An illuminated candy carrier is provided for use by children on Halloween. A large bucket-shaped container is formed in the shape of various Halloween items such as a jack-o-lantern, a ghost, a vampire or the like. At the base or bottom of the container is a battery holder designed to hold two AA or C type batteries, along with a switch, and an incandescent lamp identical to the type found in a flashlight. A series of “tracer” lights or sequentially flashing lights are located in the handle and are electrically connected to the same battery pack and switch. When activated, the invention produces a glowing effect throughout the container. This glow, coupled with the attention gathering characteristics of the tracer lights, helps to increase the visibility of the child carrying it on a darkened street.

### RELATED APPLICATIONS

The present invention was first described in Disclosure Document Registration filed under 35 U.S.C. §122 and 37 C.F.R. §1.14. There are no previously filed, nor currently any co-pending applications, anywhere in the world.

### BACKGROUND OF THE INVENTION

1. Field of the Invention

The present invention relates generally to ornamental and illuminated bags and, more particularly, to an Illuminated Halloween Candy Carrier.

2. Description of the Related Art

Halloween is a day of great fun for both adults and children alike. There are parties to attend, decorations to put up, scary stories to tell and so forth. But no matter how many activities one participates in, the act of trick-or-treating is the highlight. Dressing up in costumes and going door to door to get treats is simply magical for kids. About the only disadvantage to trick-or-treating is that it usually occurs during nighttime hours. While the darkness adds to the “scariness” factor, it does nothing to improve safety of the children. While flashlights do increase the visibility of the children, many children find it difficult to carry both the flashlight and the treat bag at the same time

A search of the prior art did not disclose any patents that read directly on the claims of the instant invention; however, the following references were considered related.

The following patents disclose a decoratively illuminated carrying case, especially for Halloween candy.

U.S. Pat. No. 6,059,423 issued in the name of Knopick

U.S. Pat. No. 5,984,754 issued in the name of Freelander

U.S. Pat. No. 4,926,296 issued in the name of Blume et al.

U.S. Pat. No. 4,802,071 issued in the name of Schuster

The following patents describe the design and function of an illuminated Halloween decoration.

U.S. Pat. No. 5,918,964 issued in the name of Bou

U.S. Pat. No. D 403,461 issued in the name of Friedmann

U.S. Pat. No. D 373,001 issued in the name of O'Donnell

U.S. Pat. No. D 356,167 issued in the name of Bohannon

U.S. Pat. No. D 345,621 issued in the name of McLaughlin

Consequently, there exists a need for a means by which the visibility of children who are trick-or-treating can be increased for safety.

### SUMMARY OF THE INVENTION

It is therefore an object of the present invention to provide an improved Illuminated Halloween Candy Carrier.

It is a feature of the present invention to provide an improved Illuminated Halloween Candy Carrier that consists of a large bucket-shaped container in the shape of various Halloween items such as a jack-o-lantern, a ghost, a vampire or the like.

Briefly described according to one embodiment of the present invention, an illuminated candy carrier is provided for use by children on Halloween. The invention consists of a large bucket-shaped container in the shape of various Halloween items such as a jack-o-lantern, a ghost, a vampire or the like. At the base or bottom of the container is a battery holder designed to hold two AA or C type batteries, along with a switch, and an incandescent lamp identical to the type found in a flashlight. A series of “tracer” lights or sequentially flashing lights are located in the handle and are electrically connected to the same battery pack and switch. When activated, the invention produces a glowing effect throughout the container. This glow, coupled with the attention gathering characteristics of the tracer lights, helps to increase the visibility of the child carrying it on a darkened street.

The use of the illuminated Halloween candy carrier provides for an enhanced level of safety for all children who venture outside on Halloween night.

### DESCRIPTIVE KEY

DESCRIPTIVE KEY

| | |
|---|---|
| 10 | illuminated Halloween candy |
| | carrier |
| 15 | main body |
| 20 | decorative face |
| 25 | top opening |
| 30 | fixed carrying handle |
| 35 | activation switch |
| 40 | battery cover door |
| 45 | retaining screw |
| 50 | batteries |
| 55 | internal illumination light |
| 60 | three output sequencing |
| | module |
| 65 | multiconductor cable |
| 70 | handle-mounted light bulbs |
| 75 | protective interior cover |

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of the illuminated Halloween candy carrier 10 according to a preferred embodiment of the present invention;

FIG. 2 is a rear view of the illuminated Halloween candy carrier 10

FIG. 3 is a sectional view of the illuminated Halloween candy carrier 10 taken along a line I-I as shown in FIG. 1; and

FIG. 4 is an electrical schematic diagram of the present invention depicting major electrical components.

### DESCRIPTION OF THE PREFERRED EMBODIMENTS

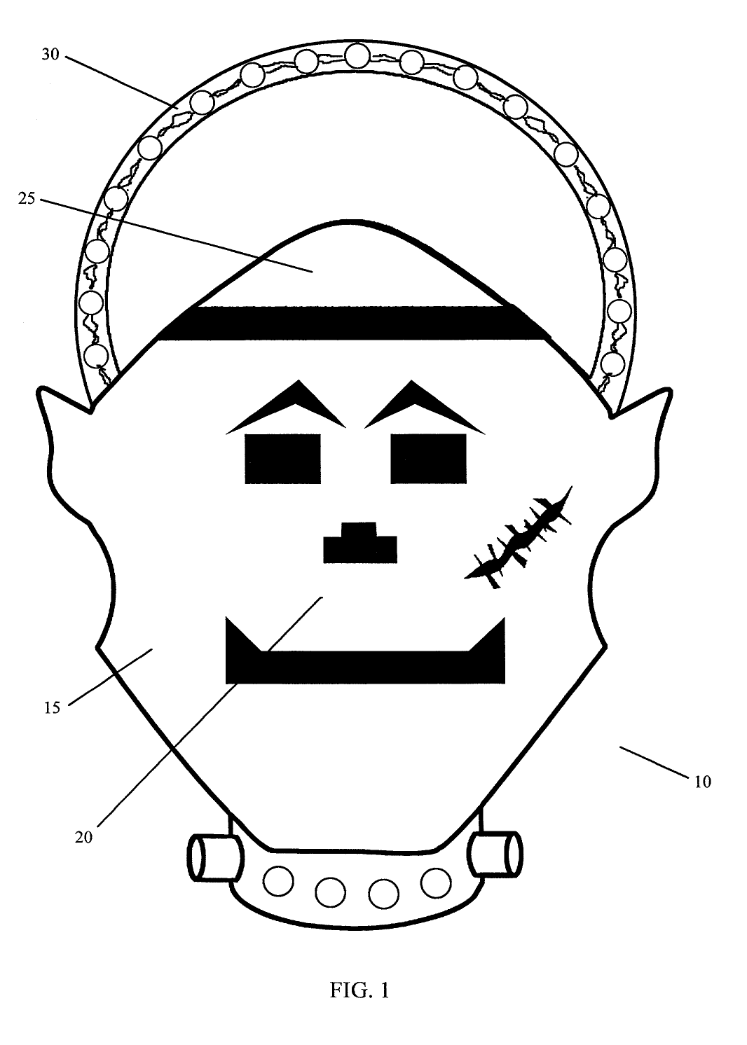

The best mode for carrying out the invention is presented in terms of its preferred embodiment, herein depicted within the FIGS. 1 through 4.

1. Detailed Description of the Figures

Referring now to FIG. 1, an illuminated Halloween candy carrier 10 is shown according to a preferred embodiment of the present invention. A main body 15 is provided and forms the major component of the illuminated Halloween candy carrier 10. For illustrative purposes, the main body 15 is depicted as a pumpkin with a decorative face 20, thereby reflecting a jack-o-lantern. However, it can be seen by those familiar in the art that other Halloween theme items, such as skulls, witches' heads, ghosts, black cats, monsters and the like could also be used. Located on the upper part of the main body 15 is a top opening 25 into the hollow interior of the main body 15. This top opening 25 is for the placement of candy or other treats one may collect while trick-or-treating door-to-door on Halloween night. The top opening 25 is sufficiently large enough so that items may be placed quickly inside as to not be cumbersome for the trick-or-treater or the provider. Finally, located above the top opening 25 is a fixed carrying handle 30. The fixed carrying handle 30 is attached rigidly to the main body 15 at two outward locations. The fixed carrying handle 30 is envisioned to be constructed of clear plastic and is of a hollow tube type arrangement that is sufficiently strong enough for both the static and dynamic forces present when carrying an illuminated Halloween candy carrier 10 filled with treats.

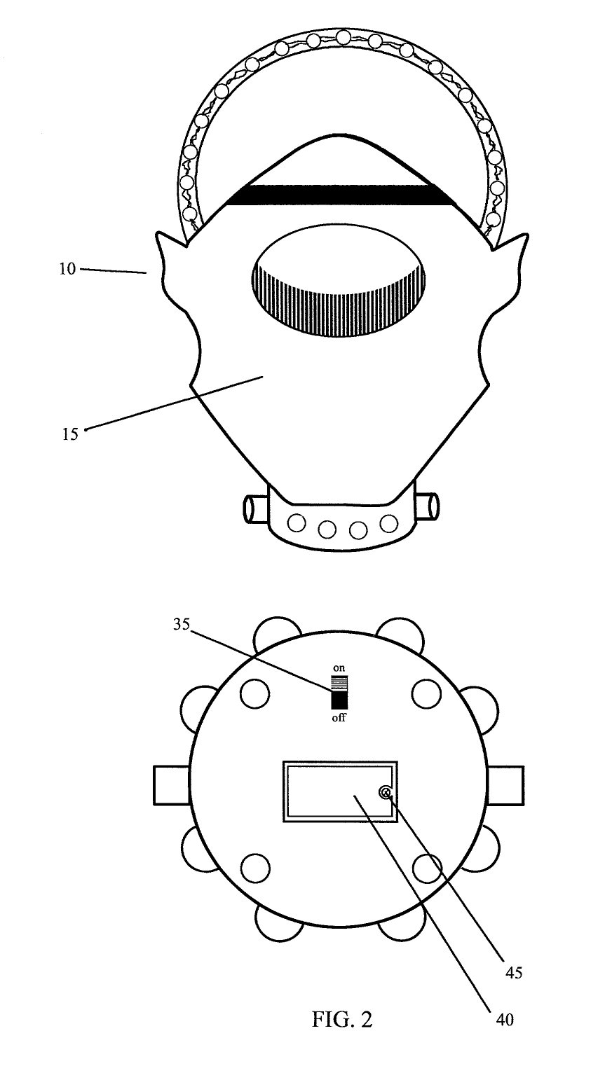

Referring next to FIG. 2, a rear view of the illuminated Halloween candy carrier 10 is depicted. An activation switch 35 is located on the upper rear portion of the main body 15 as shown. The activation switch 35 is a standard single pole, single throw switch, with the common operating positions of ON and OFF. Located immediately below the activation switch 35 is a battery cover door 40. The battery cover door 40 is used to enclose, retain and protect two internal batteries. The internal batteries are envisioned and depicted to be of the common size “AA”, though other types and sizes may also be used. Finally a retaining screw 45 is used to hold the battery cover door 40 in place and prevent dislodgment by external forces such as drops, bumps, and the like as may be encountered while carrying the illuminated Halloween candy carrier 10 during trick-or-treating duties.

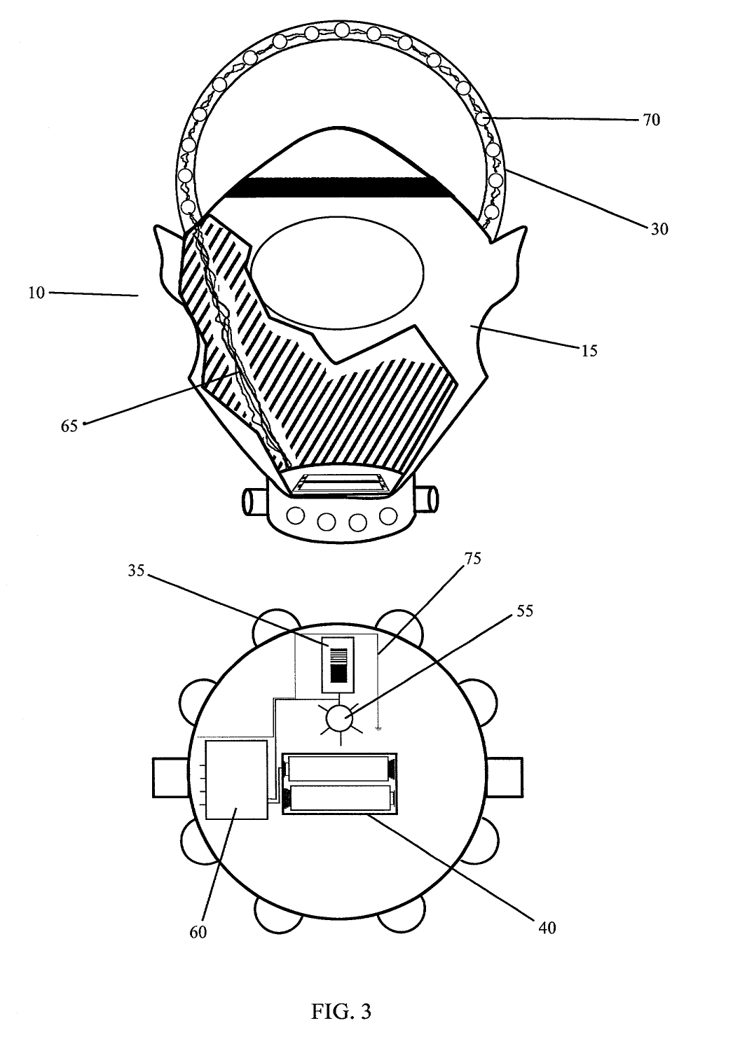

Referring now to FIG. 3, a sectional view of the illuminated Halloween candy carrier 10 taken along a line I-I as shown in FIG. 1 is depicted. Such a sectional cut is taken directly at the midpoint of the illuminated Halloween candy carrier 10 in a rearward facing manner and thus depicts a sectional cut through the fixed carrying handle 30 as well. Two batteries 50, wired in a series arrangement, are shown within the battery cover door 40. One power lead is then routed to the activation switch 35, to allow the activation switch 35 as a main disconnect for the entire electrical circuit. From the load side of the activation switch 35, two loads are served. The first load is an internal illumination light 55, located on the interior of the main body 15, directly above the battery cover door 40, but below the activation switch 35. This internal illumination light 55 is of the typical size commonly found in a flashlight and produces a similar amount of light. This light then radiates throughout the interior of the main body 15 to produce a glowing effect. A return path, or negative circuit conductor originates at the internal illumination light 55 and returns to the batteries 50 to complete the first circuit. The second load is a three output sequencing module 60 which receives power at the exact same two circuit nodes that the internal illumination light 55 does. The three output sequencing module 60 is of a standard well-known design that produces an electrical voltage on one output for a given time period, then removes this voltage and applies it to a second output for a given time period, then finally repeats the process on a third output before returning power to the first output in a continuous and repeating pattern. Such outputs can be produced by solid-state logic, electromechanical timing circuits, rotary motion circuits and the like. The actual method used in the illuminated Halloween candy carrier 10 is not intended to be a limiting factor. The various outputs of the three output sequencing module 60 are electrically transmitted by a multiconductor cable 65 to a plurality of handle-mounted light bulbs 70 located in the fixed carrying handle 30 of the illuminated Halloween candy carrier 10. The handle-mounted light bulbs 70, envisioned to be of a small, low-wattage design, commonly called “wheat lamps”, are combined in multiples of three to coincide with the three outputs of the three output sequencing module 60. While any combination of three is available for use, FIG. 3 depicts a total of 12 handle-mounted light bulbs 70 connected in four groups of three lamps apiece. Finally, a protective interior cover 75, shown in FIG. 3 with phantom lines for clarity, is provided to cover and protect the electrical components as shown. This leaves the remainder of the internal hollow cavity of the main body 15 available for candy and treat storage as described in FIG. 1.

Referring finally to FIG. 5, an electrical schematic diagram of the present invention depicting major electrical components is depicted. The batteries 50 provide electrical power for the circuit and are energized and de-energized through the activation switch 35. Power flow from the activation switch 35, when in a closed state, continues on to the internal illumination light 55 and the three output sequencing module 60. The internal illumination light 55 is illuminated in a well-known manner and the three output sequencing module 60, be it of solid-state logic, electromechanical timing circuits, rotary motion circuits or the like is energized as well. The three output sequencing module 60 then provides alternating outputs on the multiconductor cable 65 to illuminate the plurality of handle-mounted light bulbs 70. The manner and sequence in which they are illuminated give the impression that the lights are chasing one another through the handle. This tracing effect is highly visible, thus not only providing entertainment value for the person carrying the illuminated Halloween candy carrier 10, but to any motorists or other passer-byes who happen to be sharing roadways with the person carrying the illuminated Halloween candy carrier 10. This attention gathering characteristic increases the visibility factor of the illuminated Halloween candy carrier 10 and thus increases safety and reduces possible accidents.

It is envisioned that other styles and configurations of the present invention can be easily incorporated into the teachings of the present invention, and only one particular configuration shall be shown and described for purposes of clarity and disclosure and not by way of limitation of scope.

2. Operation of the Preferred Embodiment

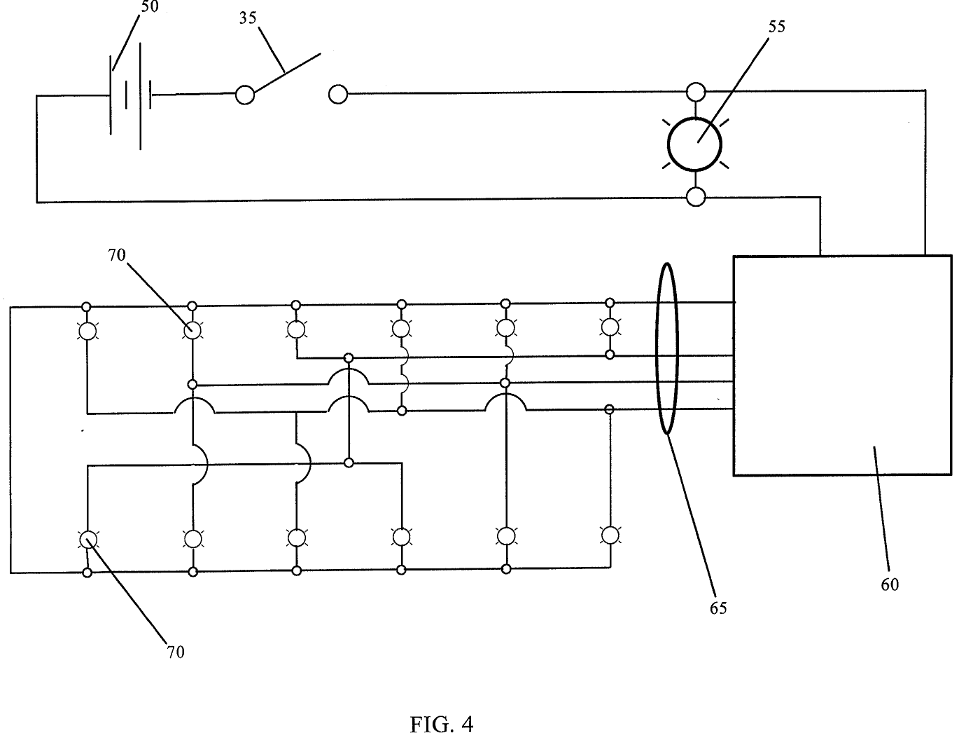

The preferred embodiment of the present invention can be used by the common user in a simple and effortless manner. The operation of the illuminated Halloween candy carrier 10 is best described in conjunction with FIG. 1, FIG. 2, FIG. 3, and FIG. 4.

To use the illuminated Halloween candy carrier 10, one would ensure that fresh batteries are placed in the illuminated Halloween candy carrier 10 and secured by the battery cover door 40 and the retaining screw 45. Next, when trick-or-treating at dusk or during nighttime hours, the child or person carrying the illuminated Halloween candy carrier 10 would activate the internal illumination light 55 and the handle-mounted light bulbs 70, by switching the activation switch 35. Then, with the internal glow provided by the internal illumination light 55 and the attention gathering characteristics of the handle-mounted light bulbs 70 in their chasing or sequential manner, one would continue to advance from residence to residence on foot to collect candy and/or treats in the hollow center of the main body 15, secure in the knowledge that they are visible to any motorists. When finished with trick-or-treating, the user simply deactivates the illuminated Halloween candy carrier 10 by use of the activation switch 35 and empties the contents of the main body 15 out for consumption.

The foregoing description is included to illustrate the operation of the preferred embodiment and is not meant to limit the scope of the invention. The scope of the invention is to be limited only by the following claims.

What is claimed is:

1. An illuminated Halloween candy carrier comprising:
a main body forming a top opening into the hollow interior of the main body, said top opening being sufficiently large enough so that items may be placed quickly inside;
a fixed carrying handle attached rigidly to said main body at two outward locations;
illumination means located within said hollow interior for providing illumination outward from said main body.

2. The illuminated Halloween candy carrier of claim 1, wherein said main body supports and forms a decorative face about an outer surface.

3. The illuminated Halloween candy carrier of claim 2, wherein said decorative face is selected from the group comprising jack-o-lantern, skulls, witches' heads, ghosts, black cats, and monsters.

4. The illuminated Halloween candy carrier of claim 1, wherein said fixed carrying handle is constructed of clear plastic and is of a hollow tube type arrangement that is sufficiently strong enough for both the static and dynamic forces present when carrying an illuminated Halloween candy carrier.

5. The illuminated Halloween candy carrier of claim 1, wherein said illumination means comprises:
an illumination light which radiates throughout the interior of the main body to produce a glowing effect;
a battery source in electronic communication with said lamp; and
an activation switch in electronic control with said battery source and located on an upper rear portion of the main body.

6. An illuminated candy carrier comprising:
a bucket-shaped container forming an outer surface circumscribing an inner volume;
a handle affixed to a top of said container;
a battery holder designed to hold batteries, along with a switch, and an incandescent lamp identical to the type found in a flashlight;
wherein said battery holder and incandescent lamp are located at a base formed in a bottom of said container.

7. The illuminated candy carrier of claim 6, further comprising a decorative shape formed on said outer surface.

8. The illuminated candy carrier of claim 7, wherein said decorative shape is selected from various Halloween items selected from the group comprising jack-o-lantern, a ghost, and a vampire.

9. The illuminated candy carrier of claim 6, further comprising:
a series of sequentially flashing lights in said handle, said flashing lights being in electrical connection with said batteries and switch.
